(19) United States
(12) Patent Application Publication
(10) Pub. No.: US 2021/0272201 A1
(43) Pub. Date: Sep. 2, 2021

(54) SYSTEMS FOR OPTIMIZING TRADE EXECUTION

(71) Applicant: Roman Ginis, Stamford, CT (US)

(72) Inventor: Roman Ginis, Stamford, CT (US)

(21) Appl. No.: 17/322,793

(22) Filed: May 17, 2021

Related U.S. Application Data
(63) Continuation of application No. 16/148,721, filed on Oct. 1, 2018, now abandoned.
(60) Provisional application No. 62/566,789, filed on Oct. 2, 2017.

(51) Int. Cl. G06Q 40/04; G06Q 30/02; G06N 20/00

(52) U.S. Cl. CPC G06Q 40/04; G06N 20/00; G06Q 30/0201

(57) ABSTRACT

Systems and methods for optimizing trade execution by computing market reaction to recent trades of a security; calculating matching parameters for the security in response to the computed market reaction and at least one of historical market data and real-time market data; calculating a trade window for the next match; and executing the trade during the window.

### CROSS-REFERENCE TO RELATED APPLICATIONS

This application claims priority to U.S. Provisional Application No. 62/566,789, filed on Oct. 2, 2017, the contents of which are incorporated herein by reference.

### BACKGROUND OF THE INVENTION

The efficiency of public markets can have enormous effects on investors in securities. The additional trading expense of a single penny per share can impose a cost on large volume traders, such as mutual funds, pension funds and hedge funds, in the hundreds of millions of dollars per year. Such trading costs are necessarily passed on to customers and clients as “execution costs” and directly reduce an investor's returns. When compounded over decades, even such relatively small trading inefficiencies add up to very large sums, impacting everyone with a stake in the markets from individual retirees to entire economies.

Securities exchanges play a key role in facilitating trading between market participants. In a simple mechanical sense, exchanges match investors' respective buy and sell orders and report on the completed trades. Their matching processes follow prescribed sets of rules that govern which orders are eligible to be matched and when. The efficiency of a market in a particular security depends on how well such matching rules are designed and implemented.

In exchanges using Limit Order Book (LOB) methods, market participants place orders to buy or sell a security for particular prices in particular quantities. An order to buy a security for a price equal to or lower than a specified value in a certain quantity is called a “bid.” An order to sell a security for a price equal to or higher than a specified value in a certain quantity is called an “offer.” The bid(s) with the highest price is called the “best bid” and the offer(s) with the lowest price is called the “best offer.” During an active market, there may be bids and offers at a variety of different prices. At any particular time, the set of all bid and offer prices, as well as their aggregate quantities at those prices, is the state of the LOB.

During an active trading day, market participants will place bids and offers for each security at different times, thereby providing opportunities for immediate access to the security for the market at large. This is known as liquidity. Market participants who wish to trade by accepting such bids and/or offers can place orders to immediately transact at the best available price. Those are known as market orders.

In an LOB-based system, the price of the best bid is typically lower than the price of the best offer. If not, those orders could be matched, resulting in a trade. The size of the trade would be the maximum share quantity available to match, i.e., the smaller of the best bid quantity and the best offer quantity. After the trade is completed, the best bid and best offer quantities are effectively reduced by the size of the trade. Matching continues until the quantity of matchable best bids or best offers is exhausted. After the matchable bids/offers are exhausted in the LOB-based system, a gap exists between the best bid price and best offer price.

An LOB method or system that allows a trade to happen as soon as a bid and an offer are matchable during the trading day is called a Continuous Limit Order Book (CLOB). An LOB method or system that restricts matching to occur at specific times during the trading day is called a Discontinuous Limit Order Book (DLOB).

The most common rule set in the United States' securities market implements CLOB, and is generally optimized for immediacy of matching and speed of execution. One advantage of CLOB is that it may enable market participants to “price-in” new information quickly. Examples of such information include corporate earnings updates, the release of economic data by the government, recent financial market activity, breaking news, and other events that have material impact on security prices. CLOB also usually works well for small (retail-sized) orders, enabling relatively smaller-sized bids and offers to be matched within microseconds.

However, a CLOB-based system often does not work as well for institutional investors, such as 401(k) plan managers and mutual funds, and other investors seeking to trade relatively large quantities of a security. Certain features of a CLOB-based system that enable it to match orders quickly also results in a disadvantageous side-effect: certain market participants may be able to develop an informational advantage over other market participants and trade on that information to the detriment of those other market participants. While the existence of additional bids and offers based on that informational advantage can result in trades that provide additional liquidity for a particular security, that type of trading can also impose significant costs on institutional investors seeking to trade a large quantity of the security.

An example of an additional cost that is particularly harmful to institutional investors participating in a CLOB-based system is “adverse selection.” Colloquially known as “getting picked off,” adverse selection happens when another party (the “asymmetric counterparty”) trades against an investor's limit order for a security just before the price of that security is about to move, e.g., just after the release of information that will move the market in favor of the investor. That asymmetric counterparty is typically a short-term trader utilizing an accurate short-horizon statistical price forecast, e.g., a high-frequency trader using a price forecast model that anticipates the imminent price change. Such asymmetric counterparties will, for example, issue orders to match the investor's relatively large order faster than the investor can modify or cancel its order and then duplicate the investor's original order to secure a profit when the forecasted price change occurs. In that way, the asymmetric counterparty profits at the expense of the investor.

Adverse selection can be measured, for example, by the average change in price after a trade occurs. If a trader buys stock for $100/share and the price of that stock falls to $95 shortly after the purchase, the trader may assume that the $5 difference in price is adverse selection barring some other superseding market force.

An alternative market design implements a DLOB-based system, where the matching of orders happens at scheduled times, rather than continuously, during the trading day. Such designs have been tried since the 1980's with limited success. Introducing discontinuities into the matching process, e.g. rounds of matching occurring at particular times, can reduce short-horizon adverse selection, but often introduces a liquidity problem: orders that have been delayed until the next matching round miss out on matching with orders that expire during the delay.

Conventional DLOBs usually match periodically, e.g., every 100 milliseconds, 5 seconds, or other time interval. Some existing DLOBs are slightly randomized by matching every 250 to 500 milliseconds. However, because the DLOB's time interval for a match does not depend on trading dynamics, it is usually too infrequent for certain securities or too frequent for other securities. The more frequent the matching the more liquidity in the market for that security, but more adverse selection results. Lacking any calibration, especially a dynamic calibration of the matching frequency per security, volatility regime, spread, time of day, etc. existing DLOBs have been commercially unsuccessful.

Another example of market inefficiency for institutional investors is the change in the price of a security in response to their orders and trades and is known as “market impact.” As institutional investors place orders and engage in trades at exchanges and at alternative trading systems (ATSs), some market participants are able to forecast the direction of the institutional investors' orders (whether a bid or offer or combination of the two), by detecting patterns in order placements and changes in a security's price over time. Such participants often then act on those forecasts to cancel or adjust their own orders, or even trade ahead of the forecasted institutional investor's orders. The result is that the institutional investor receives worse matching of its orders for a security. Those market participants effectively profit at the institutional investors' expense.

### SUMMARY OF THE INVENTION

An embodiment of the present invention makes it possible to create a more efficient securities market, reducing both adverse selection and market impact effects for investors, while maximizing liquidity, by a new use of machine learning to calibrate and control matching engine rule sets. In accordance with an embodiment of the invention, machine learning is used in a control loop, continuously incorporating new data from the market and the matching engine, to adjust a matching time window to yield better matches. The Machine Learning Engine (MLE) is capable of optimizing several parameters, depending on the priorities of the operator.

For example, in accordance with one embodiment of the invention, one can combine the benefits of a CLOB and a DLOB by using machine learning to compute optimum scheduled matching times—making them close-enough in time for each security to offer maximum liquidity, yet far-enough in time to make a trade that results in adverse selection for the investor having a relatively large order unprofitable for another market participant to implement systematically. The net effect should is a reduction in adverse selection experienced by the investor having a relatively large order. Alternatively, the MLE may direct the matching engine to only partially fill an order to reduce the market impact and minimize adverse selection.

Another embodiment of the present invention can improve execution of an order book by choosing the size and price for each match that provides less information to the market about an investor's relatively larger order, to make forecasting the actual size and price of that order more difficult, if not impossible, and reduce the market impact as that order is matched.

According to a further embodiment of the present invention, a method of optimizing trade execution is provided that includes the steps of: computing a market reaction to a recent trade of a security; calculating a matching parameter for the security in response to the market reaction and at least one of a historical market data for said security and a real-time market data for said security; and executing a trade of the security in accordance with the matching parameter.

According to yet another embodiment of the present invention, a system for optimizing security trade execution includes a processor for computing a market reaction to a recent trade of a security; a machine learning engine for calculating a matching parameter for the security in response to the market reaction and at least one of a historical market data and a real-time market data; and a matching engine for executing a trade of the security in accordance with the matching parameter.

### BRIEF DESCRIPTION OF FIGURES

FIG. 1 shows system architecture 100 according to an embodiment of the present invention.

FIG. 2 shows a block diagram of a system and method according to another embodiment of the present invention.

FIG. 3 is a flowchart showing a method for computing optimal matching time according to a further embodiment of the present invention.

FIG. 4 is flowchart showing a method for executing a trade according to another embodiment of the present invention.

### DETAILED DESCRIPTION OF THE INVENTION

An improved order matching system and method is disclosed. To facilitate explanation, and not by way of limitation, embodiments of the present invention are explained in terms of systems and methods for matching securities such as corporate stocks. Embodiments of the present invention are not limited to the trading of such securities but may be beneficially implemented to trade bonds (e.g., corporate, government, special purpose), currencies, options, derivatives, other financial instruments (e.g., loans, leases, mortgages, notes, commercial paper, and the like), commodities, real estate, other physical assets, digitized assets, cryptocurrencies, and the like.

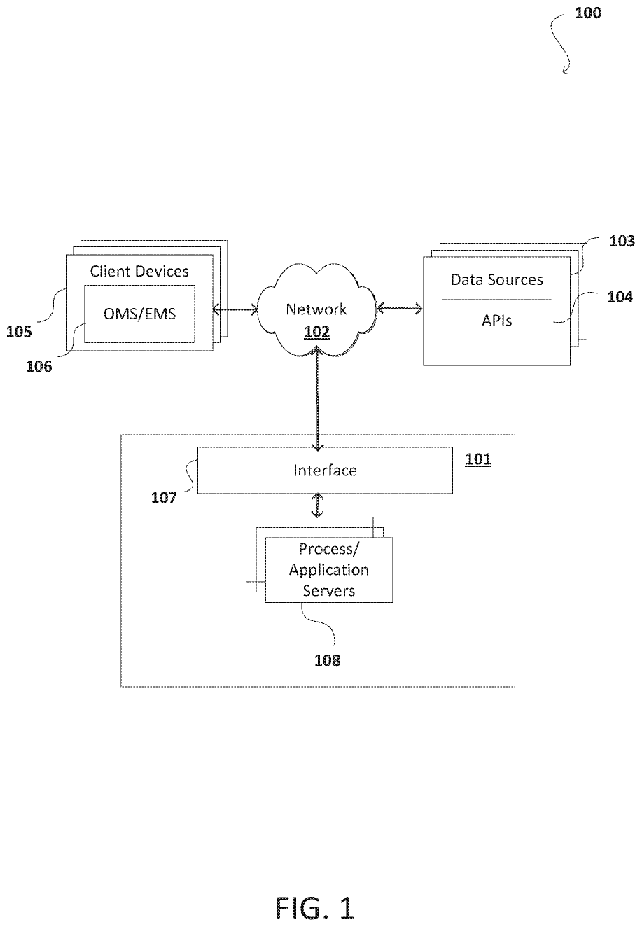

FIG. 1 shows system architecture 100 according to an embodiment of the present invention. In system 100, computerized exchange 101 and client devices 105 are connected via a network 102. Computerized exchange 101 is also connected via network 102, or via a different network (not shown) to one or more data sources 103, each optionally having an application programming interface (API) 104. Preferably, network 102 also connects data sources 103 with client devices 105 to allow such devices to access data that is the same as, similar to, or a subset of the data received by computer exchange 101 from data sources 103.

Computerized exchange 101 preferably includes one or more process or application servers 108 and, optionally, interface 107. Servers 108 execute trades and may be configured to interoperate via an internal network structure or may have a hierarchical structure as, for example, a presentation server, a database server, an applications server, and other related servers that are together configured to implement aspects of embodiments of the present invention. Servers 108 are preferably mainframe computers, cloud servers, or distributed computing networks.

Interface 107 is preferably an application program interface (API) such as a local API, web API or program API and, alternatively, can be a network interface controller that connects a computer to a computer network or a virtual network interface connecting a computer to a virtual private network. Alternately, interface 107 can be an interface application that provides a user interface for users interacting with computerized exchange 101 in order to, for example, place orders, monitor trades, review market data, and the like.

Network 102 is preferably a communications network using one or more commercial communications protocols, such as TCP/IP, FTP, UPnP, NFS, or CIFS. Network 102 can be wireless or wired—including a local area network (LAN), a wide-area network (WAN), a virtual private network (VPN), the internet, an intranet, an extranet, a public switched telephone network (PSTN), a cellular network, a satellite communications network, an infrared network, another type of wireless network, and the like, or a combination of the foregoing.

Data sources 103 are preferably markets, exchanges, and/or market reporting services that provide historical and real time price and trading data regarding, for example, securities, bonds, currencies, derivative products, or the like. API 104 is preferably a local API, web API or program API and, alternatively, can be a network interface controller that connects a computer to a computer network or a virtual network interface connecting a computer to a virtual private network. Alternately, API 104 can be an interface application that provides a user interface for users interacting with one or more of data sources 103 in order to, for example, monitor trades, review market data, and the like.

Client devices 105 are preferably conventional computing devices such as a personal computer, tablet computer, or smart phone that runs, or is part of, a conventional order management system (OMS) or conventional execution management system (EMS). Client devices 105 preferably provide a user interface for an individual user to place orders, monitor trades, review market data, review account status, and the like. Client devices 105 optionally include an internet browser or mobile application for placing orders and receiving information regarding order status. Alternatively, client devices 105 include one or more computers running a trading algorithm or the like for trading, for example, securities, bonds, currency, derivative products, and/or the like.

In a preferred operation, users enter orders via one or more client devices 105. Client devices 105 transmit the orders to computerized exchange 101 via network 102. Optionally, users access market data from data sources 103 via network 102. Computerized exchange 101 receives historical and current market data from data sources 103 via network 102. Orders received by computerized exchange 101 are subject to a matching process by servers 108. After the matching is performed and the orders are filled, information regarding the filled orders is transmitted to data sources 103 via network 102 and/or to other market participants or the like (not shown).

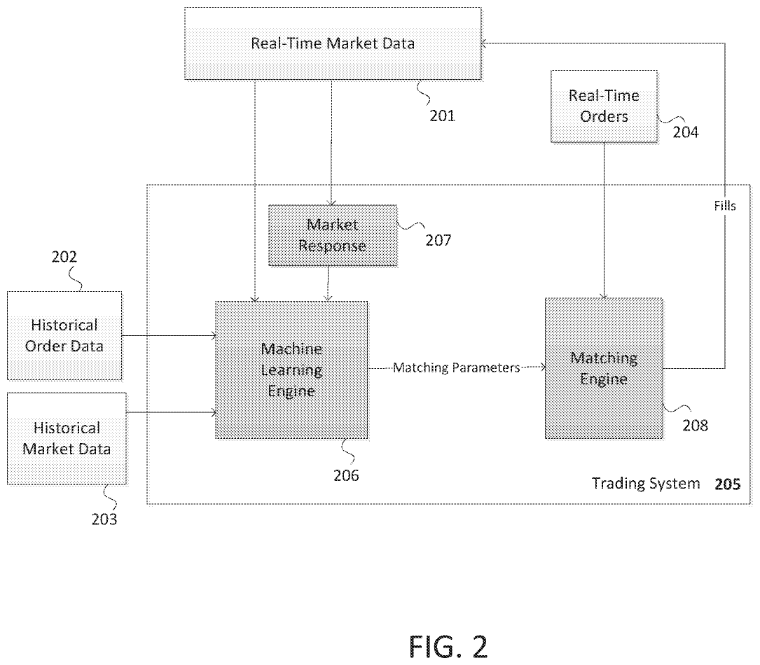

FIG. 2 shows a functional block diagram of a system or method according to an embodiment of the present invention. A preferred embodiment of computerized exchange 101 is presented as trading system 205. Trading system 205 comprises machine learning engine 206, market response module 207, and matching engine 208. Preferably, machine learning engine 206 receives real time market data 201, historical order data 202, historical market data 203, and market response data 207 and utilizes each to compute order matching parameters that are provided to matching engine 208. Matching engine 208 uses the matching parameters to match real-time orders 204 to minimize adverse selection.

Real time market data source 201 provides real-time market data for the prices, sizes, timing, etc. of, for example, securities, bonds, currencies, derivative products and the like. Such data is obtained from either a stock exchange, alternative trading platform, or from another reliable market data source. Historical order data source 202 provides historical data for the prices, sizes, timing, etc. of orders of, for example, securities, bonds, currencies, derivative products and the like. Historical market data source 203 provides historical market data for the prices, sizes, timing, etc. of, for example, securities, bonds, currencies, derivative products and the like. The market data provided to machine learning engine 206 preferably includes all published prices of orders and trades over time (historical) and streaming during trading (real-time), and summary statistics computed from such market data. Such statistics may include for, example, price volatility, changes in spread, buy/sell order imbalances on visible markets, the timing between size changes, recent trade sizes, the ratio of trade sizes to the order book sizes, and the ratio of prices of the trades to the prices in the book at the time of the trade.

Data sources 201, 202, and 203 are preferably data sources 103. Real time orders 204 may preferably be provided by client devices 105.

Market response module 207 determines how a recently filled order has impacted the market price of the traded item; for example, a traded security at a particular time after the trade is completed. As a simple example, the amount the price of a traded item increases or decreases after a trade is, absent other superseding market forces, considered to be the market impact of the trade. In more advanced market response implementations, multiple price movements in reaction to multiple trades may be evaluated to discern patterns in the market response to determine market impact. Optionally, market response module 207 utilizes historical order data 202 and/or historical market data 203 in determining the market impact of past orders on the market price of a traded item.

Preferably, market response is measured by the changes in the book after a particular event such as, for example, an order is submitted into matching engine 208 or a particular trade is executed. The differences between the book before and after those events can be measured in many ways. For example, the book differences may be measured as the ratio of each price/level/size on the bid to a comparable price/level/size on the offer. Another example measurement is a comparison of a weighted sum of bid sizes versus a weighted sum of ask sizes.

To track the market response after a trade, market response module 207 monitors the changes in order prices and sizes on the available venues that disclose the contents of their order books and the subsequent trades that follow the trade of interest. Examples of data preferably monitored by market response module 207 includes the timing, sizes and/or prices of the subsequent trades. In an equities market, for example, market response module 207 preferably tracks the new Best Bid and the new Best Offer which reflects the then-current best price of a security for an immediate transaction.

Machine learning engine 206 and matching engine 208 preferably run as one logical system. Machine learning engine 206 preferably informs matching engine 208 of optimized matching parameters it has calculated, e.g., about when to match orders, how much of an order to match, and at what price the match should occur to execute a trade or series of trades.

The term “machine learning” refers to a process of “training” a computer to produce the desired output for a given set of inputs. Training involves systematically presenting a computer with examples of inputs and outputs. The “learning” happens when the computer integrates all of the examples into a large model of the relationship between inputs and outputs, and gains an ability to predict with increasing accuracy the correct output in response to a set of new inputs. The accuracy of the output of machine learning engine 206 may be determined, for example, by testing it with new inputs and measuring the “error” between the predicted output values and the “correct” output values.

Numerous machine learning methods are known in the art. Such methods may vary by how the computer represents the information contained in examples provided to the computer and by the type of training processes the system utilizes to “learn.” Examples of machine learning systems and methods include neural networks, regressions, Bayesian methods, and deep learning methods.

In an embodiment of the present invention, machine learning engine 206 is trained on data from orders submitted as real-time orders 204 as well as market data from other exchanges and trading venues included in real time market data 201. Preferably, machine learning engine 206 utilizes a combination of real time market data 201, historical order data 202, historical market data 203, and real-time orders 204 to develop a predictive model regarding particular traded items, e.g., securities. Such data may include historical and live orders, as well as the observed adverse selection and market response after a trade is executed. The goal for machine learning engine 206 is to develop a predictive model that will predict which matching times, order prices and order sizes will minimize adverse selection and market response.

In this context, adverse selection is preferably measured by the difference in price between the new market price of a security and the actual trade price of the security at a series of time points after a trade is executed. For example, machine learning engine 206 may calculate

AdvSel_at_time_0=price_at_time_0−trade_price

AdvSel_at_time_1=price_at_time_1−trade_price

. . .

AdvSel_at_time_n=price_at_time_n−trade_price

where n equals time steps (e.g., microseconds) of time after the trade and trade_price is the price at which a particular trade was executed. The time steps may alternatively count significant events such as quote changes or other trades.

The “price_at_time_n” may be an actual National Best Bid and Offer (NBBO), or a statistic computed from the current and recent displayed prices. Some alternative statistical methods include Recent Volume Weighted Average Price (VWAP) and Weighted-Mid Price. According to a Recent VWAP methodology, “recent” is computed over the previous N trades, or over a K period of time, or a V recent volume. According to a Weighted-mid price method, the price is computed from all available displayed prices on exchanges and Alternative Trading Systems (ATSs) that make their order books available, where the contribution of each price to the result is weighted by the size of the displayed order.

As machine learning engine 206 processes more data over trading days, the accuracy of the matching parameters should improve. The machine learning approach is superior to any static rule set because it automatically adapts to changing market conditions while attempting to minimize adverse selection and/or market response. For example, machine learning engine 206 may learn to match orders more quickly on a higher volatility day than on a low volatility day while a static rule set would match orders at the same rate regardless of the amount of volatility that day.

Machine learning engine 206 can be implemented utilizing conventional machine learning algorithms in accordance with alternative embodiments of the present invention. A preferred embodiment uses the reinforcement learning and supervised learning methods for creating an optimal matching model for each security.

Using a reinforcement learning methodology, machine learning engine 206 is trained to make specific decisions by being exposed to an environment where it trains itself continually using trial and error. Machine learning engine 206 learns from past experience and attempts to learn what decisions yield better results. An example of a reinforcement learning methodology is a method that follows the Markov decision process.

Supervised learning is a machine learning method of inferring a function from training data. The training data consists of a set of training examples. Machine learning engine 206 preferably implements supervised learning with each training example being a pair consisting of an input object (typically a vector) and a desired output value (also called the “supervisory signal”). The training process continues until machine learning engine 206 has adjusted its model sufficiently to achieve a desired level of predictive accuracy. Examples of supervised learning include, but are not limited to, regression, decision tree, random forest, KNN, and logistic regression. Other common methods of machine learning are disclosed at https://en.wikipedia.org/wiki/Machine_learning (last accessed Oct. 2, 2017) and are hereby incorporated by reference.

Other machine learning methods that can be advantageously implemented in machine learning engine 206 in an embodiment of the present invention include variants of deep learning methods. Deep learning (also known as deep structured learning or hierarchical learning) is based on learning data representations, as opposed to task-specific algorithms. Deep learning methods can be supervised, partially supervised, or unsupervised.

In another embodiment of the present invention, machine learning engine 206 receives as inputs: historical market data, real-time market data, statistics computed from market data (recent volatility, recent returns, recent trades, book pressure, trader pressure), and market response (book changes measured at various points in time after each trade from the matching engine, as well as the trades that follow) and receives as outputs: match time range (minimum, maximum) for when to execute the next match(es), match size range (minimum, maximum) for how much of an order to match, match residency targets (minimum, maximum) for future orders for how long each order needs to be on the book to participate in a match, and size allocation for orders for the next match(es). In a further embodiment of the present invention, machine learning engine 206 inserts random matching times, sizes, and prices into its instructions to matching engine 208 to reduce the ability of other market participants to forecast its operations.

In a preferred operation, machine learning engine 206 starts either in an initial state either constructed by hand by an expert or in a random state. Machine learning engine 206 is then connected to historical order data 202 and historical market data 203 and real time market data 201 and begins generating matching parameters to be used by matching engine 208. After each trade completed by matching engine 208, market response module 207 computes the market impact at various time points after the trade and the market impact data is provided to machine learning engine 206 to update to its internal model with the new information, e.g., input/output pairs.

Machine learning engine 206 repeats the learning process until a local optimum is found where adverse selection and/or market impact are minimized and subsequent training does not improve the result significantly. Optionally, machine learning engine 206 can then start from a new state and continue learning to find a new optimum. Each different learning algorithm may have a different representation of its state as well of its threshold for updating its learning. For example in a neural network, the state of the learning process is encoded in the weights on the links between the neurons, the firing threshold for each neuron, and in the thresholding function.

In a further alternative embodiment, machine learning engine 206 can issue a matching parameter to matching engine 208 to intentionally engage in a partial fill of one or more orders.

Machine learning engine 206 may update its internal model continuously or at different times to provide matching engine 208 the best possible matching parameters. Preferably, matching engine 206 operates frequently enough to adapt rapidly to new market conditions as well as react to the activities of market participants. Conventional matching logic does not adapt to such changing circumstances.

Matching engine 208 is a conventional ATS or exchange matching engine that receives buy and sell orders and produces trades. For example, a “buy” order can be “market” (to buy at the immediately available price) or “limit” to buy at a price less than or equal to the given limit. A “sell” order can be “market” (to sell at the immediately available price) or “limit” to sell at a price greater than or equal to the given limit. Typically, a match is produced by matching engine 208 when there is at least one buy order and one sell order having prices that overlap and local regulations for price protection are satisfied. In the United States, Regulation NMS provides that a venue cannot make a match if the prices of its orders are outside of the NBBO of certain “protected” venues, e.g., the exchanges at the time of the match.

Orders that qualify for matching by price are paired up in a specified order. Typically matches are ordered based on the size priority, time priority, or a pro-rata allocation. For example, orders may be required to have a certain time period of “residency” on the order book to qualify for matching (e.g. a minimum number of microseconds). Thus, if an order is “too new,” it may not qualify for matching. Alternatively, orders may be required to be a certain minimum size in order to qualify for matching. The minimum sizes may be specified by the rules of the exchange, by the entity submitting the order, or by the matching algorithm.

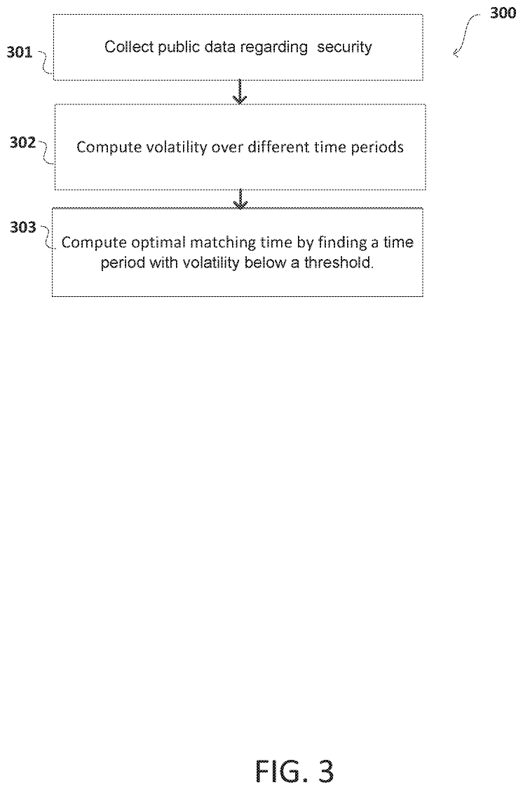

FIG. 3 is a flowchart showing how optimal matching time is computed by machine learning engine 206 according to an embodiment of the present invention. Preferably, the calculation of optimal matching times is made for individual securities based on publicly available data and real-time orders submitted to matching engine 208.

Public data and order data submitted to matching engine 208 is collected at step 301. This data is used to compute the historical volatility in a security at various times during a trading day (step 302). Volatility is a measure of the statistical variation in a security's price and is typically computed as of a specific time. For each time point in a trading day, volatility can be computed over various time periods. Volatility values are used by matching engine 208 to compute an optimal matching time for a security by identifying the time periods where the volatility is below a threshold value (step 303).

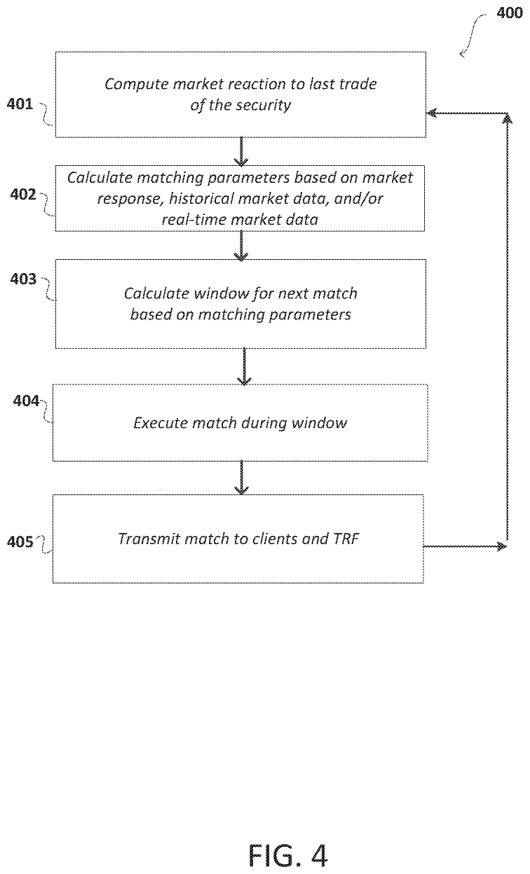

FIG. 4 is flowchart according to an embodiment of the present invention. The steps shown in FIG. 4 are preferably performed by machine learning engine 206 and/or matching engine 208. First, a market reaction to the last trade for a particular security is calculated, and, preferably, the extent of any adverse selection is determined (step 401). At step 402, matching parameters are calculated using the market reaction, historical market data, historical order data, real-time order data, and/or real-time market data.

One example of a matching parameter is optimal matching time for a security as described in connection with FIG. 3. Outstanding offers and bids are matched and filled, or partially matched and partially filled, or deferred to a later time, based on the matching parameters sent by machine learning engine 206 to matching engine 208 (step 403). In step 404, each matched order (or partial order) is executed by matching engine 208. The executed order is then transmitted by matching engine 208 to a trade reporting facility (TRF), an exchange and/or another trading system (step 405).

The various implementations disclosed above are applicable in many different and varied operating environments, and on one more electronic devices that incorporate integrated circuits, chips for processing and memory purposes. The proper configuration of hardware, software, and/or firmware is presently disclosed above to improve a computer's ability to interface with market data for trading. A system or method of the present disclosure also includes a number of the above exemplary systems working together to perform the same function disclosed herein.

Most of the exemplary implementations above utilize at least one communications network using one or more commercial communications protocols, such as TCP/IP, FTP, UPnP, NFS, and CIFS. The networks 102 can be wireless or wired—including a local area network (LAN), a wide-area network (WAN), a virtual private network, the internet, an intranet, an extranet, a public switched telephone network, an infrared network, a wireless network and one or more of the above networks in a combination.

An example of the present invention can include a database formed from a variety of data stores and other memory or storage media. These components can reside in one or more of the servers, as discussed above, or may reside in a network of the servers. In certain embodiments, the information may reside in a storage-area network (SAN). Similarly, files for performing the functions attributed to the computers, servers or other network devices discussed above may be stored locally and/or remotely, as appropriate. Each computing system described above, including the client devices, may incorporate hardware elements that are electrically coupled via data/control/and power buses. For example, one or more processors in such computing systems may be central processing units (CPU) for one or more of the client devices. The client devices may further include at least one user device (e.g., a mouse, keyboard, controller, keypad, or touch-sensitive display) and at least one output device (e.g., a display, a printer or a speaker). Such client devices may also include one or more storage devices, including disk drives, optical storage devices and solid-state storage devices such as random access memory (RAM) or read-only memory (ROM), as well as removable media devices, memory cards, flash cards, etc.

The computer systems discussed above can also include computer-readable storage media reader, communications devices (e.g., modems, network cards (wireless or wired), or infrared communication devices) and memory, as previously described. The computer-readable storage media reader is connectable or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A system for optimizing security trade execution, comprising:
a market response module including a processor for computing a plurality of market reactions to a recent trade of a security at subsequent points in time;
a machine learning engine, trained on real-time orders and real-time market data, for calculating a matching parameter for said security in response to said plurality of market reactions, a historical market data, a real-time market data, a historical order data, and a real-time order data; and
a matching engine for executing a trade of said security in accordance with said matching parameter.

2. The system of claim 1, wherein said machine learning engine utilizes a plurality of computed market reactions and a plurality of historical market data to calculate said matching parameter to reduce an adverse selection after said trade of said security.

3. The system of claim 1, wherein said machine learning engine utilizes a plurality of computed market reactions and a plurality of historical market data to calculate said matching parameter to reduce a market impact after said trade of said security.

4. The system of claim 1, wherein said matching parameter is calculated to reduce an adverse selection after said trade of said security.

5. The system of claim 1, wherein said matching parameter is calculated to reduce a market impact after said trade of said security.

6. The system of claim 1, wherein said matching parameter is a trading time window.

7. The system of claim 1, wherein said matching parameter is a maximum partial fill threshold.

8. The system of claim 1, wherein said matching parameter includes a matching time.

9. The system of claim 1, wherein said matching parameter includes a matching size.

10. The system of claim 1, wherein said matching parameter includes a matching price.

11. The system of claim 1, wherein said matching parameter includes a matching residency time threshold.
